(19) United States
(12) Patent Application Publication
(10) Pub. No.: US 2018/0190014 A1
(43) Pub. Date: Jul. 5, 2018

(54) COLLABORATIVE MULTI SENSOR SYSTEM FOR SITE EXPLOITATION

(71) Applicant: Honeywell International Inc., Morris Plains, NJ (US)

(72) Inventors: Jason Yarborough, Herndon, VA (US); Sharath Venkatesha, Golden Valley, MN (US); Alan Cornett, Andover, MN (US)

(21) Appl. No.: 15/397,436

(22) Filed: Jan. 3, 2017

(51) Int. Cl. G06T 17/05; G06T 17/10; G06T 7/292; G06T 7/277

(52) U.S. Cl. CPC G06T 17/05; G06T 17/10; G06T 7/292; G06T 7/277; G06T 2207/10012; G06T 2200/08; G06T 2207/10036; G06T 2207/30232; G06T 2207/30212; G06T 2207/30204

(57) ABSTRACT

A system communicate with a plurality of units. Each of the plurality of units includes a two dimensional camera, a three dimensional camera, a multispectral camera, and/or an inertial measurement unit. Each of the plurality of units is associated with a person, a vehicle, or a robot, and each of the units collects data relating to an environment. The system receives the data relating to the environment from the plurality of units, and uses the data from each of the plurality of units to estimate the positions of the units and to track the positions of the units. The system enables the plurality of units to communicate with each other regarding the collection of the data relating to the environment, commingles and analyzes the data from the plurality of units, and uses the commingled and analyzed data to build a three-dimensional map of the environment.

### TECHNICAL FIELD

The present disclosure relates to collaborative multi-sensor systems for site exploitation.

### BACKGROUND

Site exploitation (SE) can be defined as a synchronized and integrated application of scientific and technological capabilities and enablers to answer information requirements and facilitate subsequent operations. As of today, data collection procedures in site exploitation endeavors usually involve use of a two dimensional (2D) video camera, in addition to a myriad number of biometric and forensic sensors carried by personnel. A digital camera can be used to document the condition of a site, and to capture evidence, material, and persons of interest. In order to capture structural information, current practices involve the use of sketches, which are made to correspond with photographs taken on sites in a particular environment. These sketches include buildings, areas, vehicles, etc. However, these sketches are typically rough in nature and capture only minimal information, partly because of the time critical nature of site exploitation operations.

### BRIEF DESCRIPTION OF THE DRAWINGS

FIG. 1 is a block diagram illustrating an embodiment of a system and apparatus for performing a site exploitation.

FIGS. 2A and 2B are a block diagram illustrating features and operations of a system and apparatus for performing a site exploitation.

FIG. 3 illustrates and embodiment with two site exploitation units.

FIG. 4 illustrates a tracking of locations of a site exploitation unit on a map.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

In an embodiment, a collaborative multi-sensor (CMS) system uses data from a three dimensional (3D) sensor, an inertial measurement unit (IMU), and a regular two dimensional (2D) camera to build a 3D map for a previously unknown region/terrain. An IMU is an electronic device that measures and reports a body's specific force, angular rate, and sometimes the magnetic field surrounding the body, using a combination of accelerometers, gyroscopes, and sometimes magnetometers. This 3D map can be used to support missions/tasks while advancing the technologies to support optics, virtual reality, and electronic packaging. This forms a critical feature in learning about new real world environments and capturing useful data from the field, such as structural information. Further, the data thus collected can be used to simulate virtual environments for training purposes.

Due to the inherent risk involved in site exploitation missions, site exploitation is limited to a short time to allow for safe extraction of the team. Therefore, a CMS system should be intuitive, easy to use, and should allow a person using the system to capture the environment walking at an average human's pace.

The resolution of a CMS system should be sufficient to ensure that the data collected can be analyzed at a fidelity such that useful intelligence can be extracted. The CMS system should allow users to zoom in and view items of interest from any angle assuming the data are captured.

A CMS system should include removable solid state hard drives with enough capacity for one person collecting data on a building the size of a typical grocery store.

A team using a CMS system may or may not have access to room lighting to reduce their presence, limit the amount of lights they carry, and/or speed the process. A CMS system therefore should use sensitive optics, on-board white light, and infrared lighting to increase the ambient light. This should assist in collection speed and resolution.

The user interface of a CMS system for use in the field should be simple, rugged, and tactile. The user interface can include buttons and switches for operation and also include lights for feedback.

A CMS system should have the ability to capture multiple spectrums. The capture of multiple spectrums allows for a robust analysis of the objective, thereby increasing the intelligence collected and exploited.

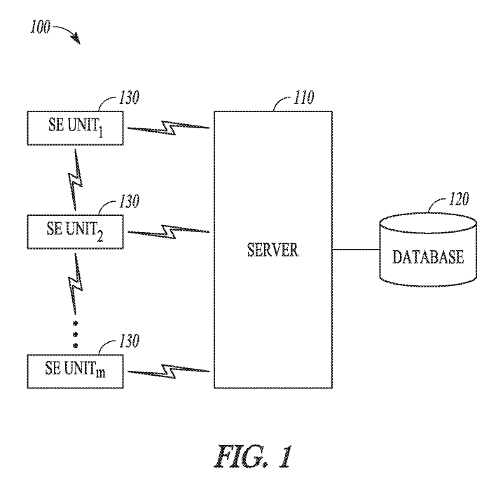

With the foregoing in mind. FIG. 1 is a block diagram illustrating an example embodiment of a system and apparatus 100 to perform a site exploitation. The system 100 includes a server 110, which is coupled to a database 120. The server 110 is also wirelessly coupled to multiple site exploitation (SE) units 130. As illustrated in FIG. 1, the site exploitation units 130 can also wirelessly communicate with each other. The server 110 can be a remote unit or it can be a mobile unit at the site. The server 110 could be in form of a mobile computing device such as a smart phone, ruggedized laptop, or be inbuilt into one of the SE units 130. The system 100 is a collaborative system, so there is no need for a centralized server, since all SE units can distribute the load amongst themselves, which can be referred to as distributed processing.

The data collection procedure in such site exploitation operations is improved by the use of a CMS system that can include low cost, low power 3D sensors and IMUs, in addition to the typically-used 2D cameras in such site exploitation systems. The data collected from the sensor system are post-processed, which completely eliminates the need for sketches. The CMS system captures data with higher accuracy than conventional site exploitation systems. The higher accuracy permits the data to be used to re-create the scenario virtually. In an embodiment, a multispectral camera (such as a thermal camera or a night vision camera) can also be used to identify other objects of interest.

A 3D sensor is capable of capturing scene depth information using multiple techniques such as stereo, time of flight (TOF), or structured light. Such 3D sensors are commercially available from many vendors including Microsoft and Intel. These 3D sensors are designed to be mounted on a helmet or other head protection device or personnel gear to provide first person point of view (POV) data. The 3D sensors can also be mounted on other movable platforms and remotely operated units such as robots, drones, and other vehicles. In an embodiment, each human or robot involved in the mission carries a unit of the CMS system. Each unit can also include an IMU, the data from which, in combination with 3D sensor data, can be used to estimate the position of the human/robot and thus track the position of the human or robot in real time, such as by visual simultaneous localization and mapping (VSLAM).

It is noteworthy that one or more embodiments do not use or depend on GPS coordinates, WiFi triangulation, or other wireless tracking/location methodologies. Consequently, areas where the CMS system can be put to use include indoor environments, wherein GPS functionality is not available and wherein there is no existing infrastructure information for location finding services/sensors.

The field of view of a camera subsystem (that is, a single 3D camera that is associated with a particular person or robot) is usually limited to about 60 degrees. This reduces the amount of information that can be collected by an individual subsystem. Power and weight requirements can also limit each person and/or remotely operated unit to carry only a single camera system. Thus, maximum benefit can be achieved if multiple subsystems in the field, within a proximal boundary, can collaborate as in a sensor network to increase the information capture. While prior methods have tried to provide optimal route maps in a known environment, in an embodiment of the present disclosure, no prior information or map exists.

In an embodiment, several CMS units communicate amongst themselves, or to a central processing station, by sharing current field of view (FOV) boundary parameters of the scene captured by 3D sensors (in terms of 3D coordinates) and the approximate physical locations of the several units. A 3D model builder calculates which “views” of the scenario are missing (in an iterative, additive manner), and provides cues to the human/robot to capture the missing views using model predictive control (MPC). For example, a person wearing the CMS system could be asked to look in a particular direction (for example, left or upwards) from his or her current position to capture data that are currently missing. The amount of the information shared across the several CMS units is small and thus can be transferred using a current wireless technology such as Bluetooth low energy (BLE), or in a Wi-Fi adhoc mesh network. The 3D data that are captured are denser, and therefore can be stored locally in each unit of the CMS system.

An embodiment efficiently reconstructs a three dimensional space, site, or other environment via stitching together data from multiple camera subsystems within the CMS system. The data from all the CMS subsystems are transferred to a server/central processing station at the end of a mission. The reconstruction can be performed offline. The data consist of the 2D locations traversed by the personnel and/or vehicles and dense 3D point cloud data (referenced in world coordinates). The IMU provides six degrees of freedom (6DOF) tracking data and re-localization is performed for available 3D landmarks in the scene. A camera re-localization module allows instant recovery from tracking failures. Incorporated into the 3D reconstruction pipeline, such a module allows seamless continuous scene mapping even when camera tracking is frequently lost. Though landmark based approaches have been used earlier, an embodiment of the present disclosure uses registered landmarks obtained from multiple CMS systems in an Extended Kalman Filter (EKF) framework to minimize errors. The frame dissimilarity (or error measure for EKF) is defined via a block-wise hamming distance. A random sample consensus (RANSAC) process is employed in the EKF to identify inliers from the visual feature correspondences between two or more image frames from different cameras. An embodiment uses data from multiple CMS systems to overcome the defects of other single camera approaches which are susceptible to problems of drift and error accumulation in the pose estimates, and the embodiment further enables scale-up of fast re-localization to larger scenes. Other standard techniques such as camera tracking using scale invariant feature transform (SIFT) features, structure from motion (SfM) for estimating 3D coordinates for landmarks, etc. can be used as part of the overall system.

The CMS system in an embodiment superimposes multi-spectral data in 3D space. Standard in painting techniques (such as Blender) can easily overlay textures on 3D point data. A dense 3D mesh is created from a set of registered 3D points and map textures from the multi-spectral data for each region in the mesh. Since multi-spectral images have poor textures, registration based only on image features is not possible. Thus for every scene, a coarse registration is performed using the multi-spectral image boundary and field of view (FOV) boundary parameters of the scene captured by 3D sensors.

In an embodiment, high performance computers are used to complete the post-processing rapidly and accurately, because analysis of the intelligence gathered from a CMS system can be time sensitive. Analysis should allow the users (intelligence personnel and/or operators) to immerse themselves in the virtual environment captured by the CMS system and to conduct repeated site exploitations (SEs) of the objective as many times as they want. Filters on the CMS system and post-processing tools allow multi-spectral views of the environment. While users are immersed in the environment, they can manipulate the data to capture, save, edit, and export data for further analysis. Additionally, the mapping of the environment provides valuable after action review data to use for entry team tactics.

In an embodiment, the data from system 100 can be used in a virtual reality (VR) system. Specifically, reconstructed 3D data from the system 100 can be used to generate a VR environment that enables a user to experience a walkthrough of the captured environment in a virtual manner using a device such as a head mounted display. The VR user is led on the paths taken by the SE units and the VR user can stop at any location and view the different virtual scenes by head motions. A map with the 2D location of the user is also shown. Certain objects in the user's filed of view can be captured only from certain vantage points, so the VR system may show coarse-blended information to the user. If detailed information (for example, complete 3D mapping of an object) is available, the VR user may switch to the detailed mode and examine the 3D model of the object.

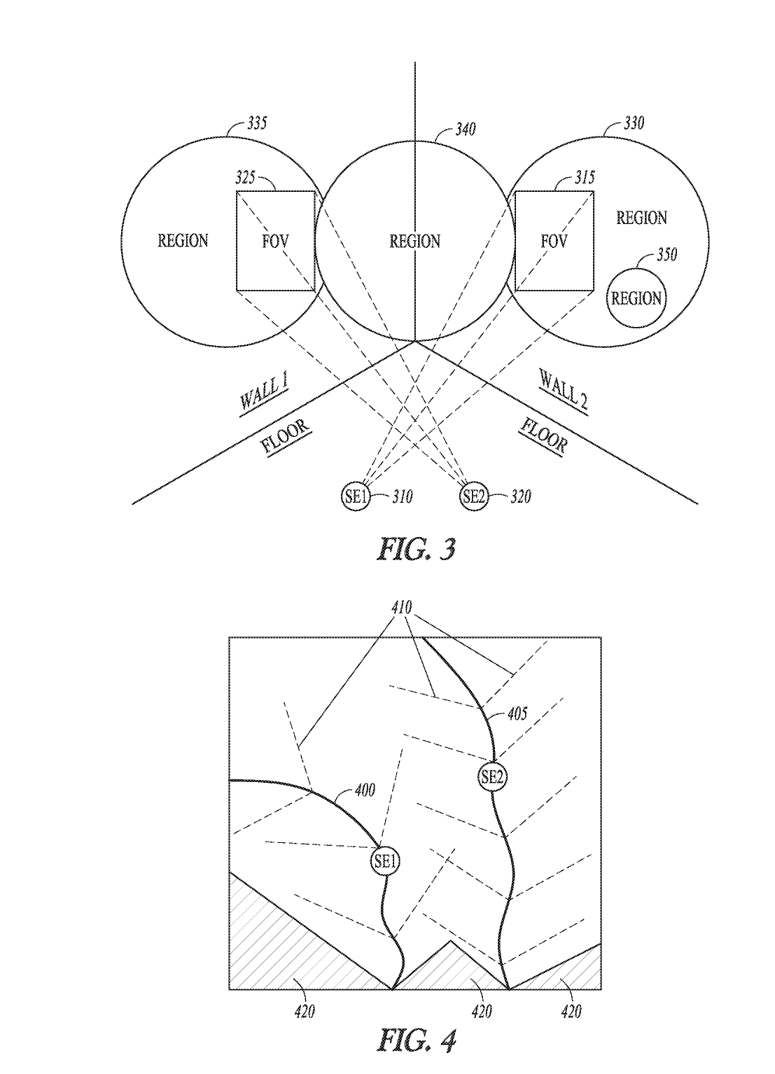

Referring to FIG. 4, using the 3D data, the system 100 is able to track the location of the SE unit in 2D and generate a track 400, 405 of the traversed map. The track information is stored in the system and can be used for virtual reality (VR) reconstruction. The VR system provides a first person view of the captured data, and the map (as in FIG. 4) shows the location where the user is with respect to the surroundings. The dotted lines 410 in FIG. 4 show the total coverage (or sweep) of the camera system at a given point on the track. The coverage of the camera system may include multiple sweeps of the camera's field of view. The regions 420 show areas that don't have 3D information available. The system can also do mute/path planning (using model predictive control) to suggest the direction that the user should go to capture missing data. This information can be shown to the SE unit as a display or voice instructions. However, the SE unit could decide to ignore the suggestions by providing a comment (for example, there is an obstruction or there is a window or opening for which the 3D depth points cannot be estimated). The system then stores this information and puts a computer generated model (say of a window) in that location, during reconstruction.

In summary, a site exploitation system should be capable of the following. It should be capable of both military and civilian use, wherein it maps activities inside a site to exploit personnel documents, electronic data, and material captured at the site, while neutralizing any threat posed by the site or its contents. It should be capable of intelligence gathering such as by mapping data that provides information necessary for mission planning. It should be capable of multi-spectral fusion, that is, a combination of 3D information with multi-spectral data. It should possess mission critical features such as taking minimal time on target to conduct site exploitation and should be thorough to ensure intelligence is not missed, and should further be capable of multi-person and multi-sensor data integration. It should have post-mission capabilities such as analyses that allow the users to immerse themselves in the virtual environments and when the user is immersed in the environment, they can manipulate the data to capture, save, edit, and export data for further analysis.

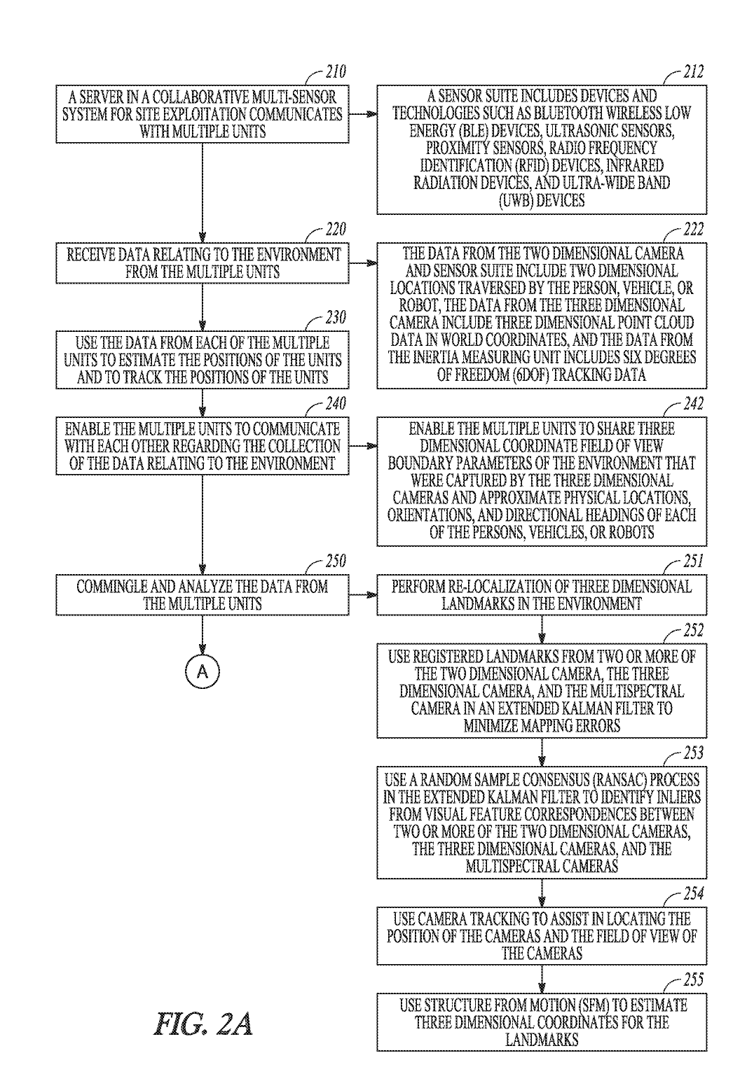

FIGS. 2A and 2B are a block diagram illustrating features and operations of a system and apparatus for performing a site exploitation. FIGS. 2A and 2B include a number of process blocks 210-274. Though arranged substantially serially in the example of FIGS. 2A and 2B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 2A and 2B, at 210, a server or other processor in a collaborative multi-sensor system for site exploitation communicates with multiple units. These multiple units can include a two dimensional camera, a three dimensional camera, a multispectral camera, a sensor suite, and/or an inertial measurement unit. As noted at 212, a sensor suite includes devices and technologies such as Bluetooth wireless low energy (BLE) devices, ultrasonic sensors, proximity sensors, radio frequency identification (RFID) devices, infrared radiation devices, and ultra-wide band (UWB) devices. Each of the multiple units is associated with a person, a vehicle, or a robot, and each of the units is operable to collect data relating to an environment.

At 220, the system receives the data relating to the environment from the multiple units. As indicated at 222, the data from the two dimensional camera and sensor suite include two dimensional locations traversed by the person, vehicle, or robot, the data from the three dimensional camera include three dimensional point cloud data in world coordinates, and the data from the inertia measuring unit include six degrees of freedom (6DOF) tracking data.

At 230, the system uses the data from each of the multiple units to estimate the positions of the units and to track the positions of the units.

At 240, the system enables the multiple units to communicate with each other regarding the collection of the data relating to the environment. As indicated at 242, the system enables the multiple units to share three dimensional coordinate field of view boundary parameters of the environment that were captured by the three dimensional cameras and approximate physical locations, orientations, and directional headings of each of the persons, vehicles, or robots. For a collaborative system, it is sufficient for a SE unit 130 to get information only from its adjacent SE units, and not from all units. The information from the adjacent units is used to map the missing areas in between them. Since the SE units are mobile, a mesh network is constantly realigned and a unit may have new neighbors at different times.

At 250, the system commingles and analyzes the data from the multiple units. The commingling and analyzing includes several operations. At 251, the system performs re-localization of three dimensional landmarks in the environment, and at 252, the system uses registered landmarks from two or more of the two dimensional camera, the three dimensional camera, and the multispectral camera in an extended Kalman filter to minimize mapping errors. At 253, the system uses a random sample consensus (RANSAC) process in the extended Kalman filter to identify inliers from visual feature correspondences between two or more of the two dimensional cameras, the three dimensional cameras, and the multispectral cameras. At 254, the system uses camera tracking to assist in locating the position of the cameras and the field of view of the cameras. At 255, the system uses structure from motion (SfM) to estimate three dimensional coordinates for the landmarks.

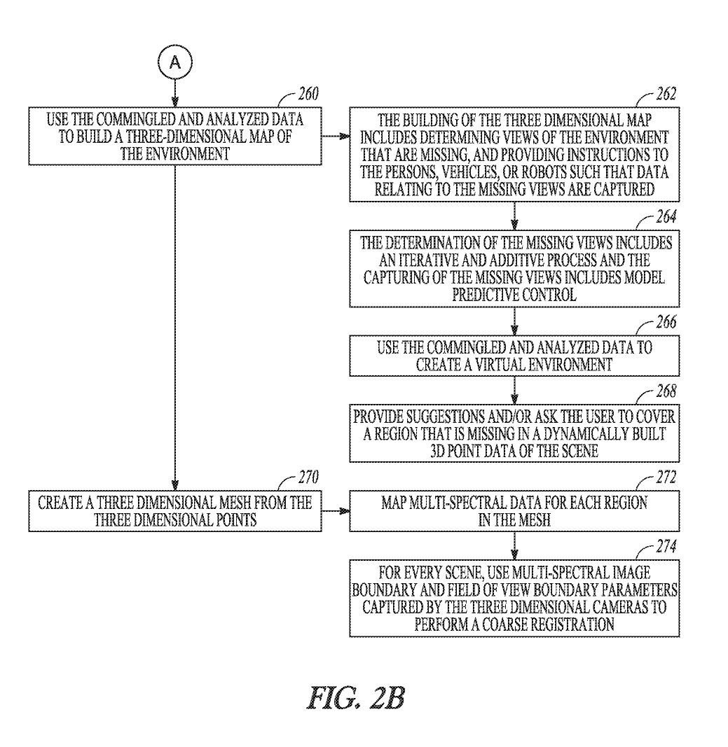

At 260, the system uses the commingled and analyzed data to build a three-dimensional map of the environment. As indicated at 262, the building of the three dimensional map includes determining views of the environment that are missing, and providing instructions to the persons, vehicles, or robots such that data relating to the missing views are captured. As indicated at 264, the determination of the missing views includes an iterative and additive process and the capturing of the missing views includes model predictive control. As indicated at 266, the system uses the commingled and analyzed data to create a virtual environment. In an embodiment, operations 262 and 264 are done offline. At 268, the system provides suggestions and/or asks the user to cover a region which is missing in a dynamically built 3D point data of the scene. When the system determines that 3D data are unavailable for a specific view angle from a SE unit's position, the system provides suggestions to the user to capture the missing region. This can be done on the fly, so that a first SE unit can capture the view from its location, or the system can ask a different SE unit to capture the view from its location. This is illustrated in FIG. 3. Referring to FIG. 3, SE units 310 and 320 are mobile units with fields of view 315 and 325 respectively. Regions 330 and 335 are already covered by SE units 310 and 320, and the 3D models of those regions are built. The system then determines that region 340 has not been covered and that data are missing. The system suggests to SE units 310 and 320 to cover the missing region 340. Region 350 is an area that was previously covered by SE unit 310, but the system determines that that previous coverage is faulty or of low resolution (that is, it shows up as a hole in the 3D depth map). The system then suggests to SE unit 310 to re-capture the region 350, and the system builds up the missing data.

At 270, the system creates a three dimensional mesh from the three dimensional points. Thereafter, at 272, the system maps multi-spectral data for each region in the mesh, and at 274, for every scene, the system uses multi-spectral image boundary and field of view boundary parameters captured by the three dimensional cameras to perform a coarse registration. Additionally, the sensor suite forms a mesh that helps to determine the approximate locations of other units in the field.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor and a computer storage device configured to:
communicate with a plurality of units, each of the plurality of units comprising one or more of a two dimensional camera, a three dimensional camera, a multispectral camera, a sensor suite, and an inertial measurement unit; wherein each of the plurality of units is associated with a person, a vehicle, or a robot and each of the units is operable to collect data relating to an environment;
receive the data relating to the environment from the plurality of units;
use the data from each of the plurality of units to estimate the positions of the units and to track the positions of the units;
permit the plurality of units to communicate with each other regarding the collection of the data relating to the environment;
commingle and analyze the data from the plurality of units; and
use the commingled and analyzed data to build a three-dimensional map of the environment.

2. The system of claim 1, comprising using the commingled and analyzed data to create a virtual environment.

3. The system of claim 1, wherein the communication regarding the collection of the data among the plurality of units comprises sharing three dimensional coordinate field of view boundary parameters of the environment captured by the three dimensional cameras and an approximate physical location, orientation, and directional heading of each of the persons, vehicles, or robots.

4. The system of claim 1, wherein the building of the three dimensional map comprises:
determining one or more views of the environment that are missing; and
providing instructions to the persons, vehicles, or robots such that data relating to the one or more missing views are captured.

5. The system of claim 4, wherein the determining the one or more missing views comprises an iterative and additive process and the capturing of the one or more missing views comprises model predictive control.

6. The system of claim 1, wherein the data from the two dimensional camera and sensor suite comprise two dimensional locations traversed by the person, vehicle, or robot, the data from the three dimensional camera comprise three dimensional point cloud data in world coordinates, and the data from the inertia measuring unit comprise six degrees of freedom (6DOF) tracking data.

7. The system of claim 6, wherein the commingling, analyzing, and building comprise:
performing re-localization of three dimensional landmarks in the environment;
using registered landmarks from two or more of the two dimensional camera, the three dimensional camera, and the multispectral camera in the extended Kalman filter to minimize mapping errors;
using a random sample consensus (RANSAC) process in the extended Kalman filter to identify inliers from visual feature correspondences between two or more of the two dimensional camera, the three dimensional camera, and the multispectral camera;
using camera tracking; and
using structure from motion (SfM) to estimate three dimensional coordinates for the landmarks.

8. The system of claim 1, wherein the computer processor is configured to:
create a three dimensional mesh from the three dimensional points;
map multi-spectral data for each region in the mesh; and
for every scene, use multi-spectral image boundary and field of view boundary parameters captured by the three dimensional cameras to perform a coarse registration.

9. The system of claim 1, wherein the sensor suite comprises one or more of a Bluetooth wireless low energy (BLE) device, an ultrasonic sensor, a proximity sensor, a radio frequency identification (RFID) device, an infrared radiation device, and an ultra-wide band (UWB) device.

10. A method comprising:
communicating with a plurality of units, each of the plurality of units comprising one or more of a two dimensional camera, a three dimensional camera, a multispectral camera, a sensor suite, and an inertial measurement unit; wherein each of the plurality of units is associated with a person, a vehicle, or a robot and each of the units is operable to collect data relating to an environment;
receiving the data relating to the environment from the plurality of units;
using the data from each of the plurality of units to estimate the positions of the units and to track the positions of the units;
permitting the plurality of units to communicate with each other regarding the collection of the data relating to the environment;
commingling and analyzing the data from the plurality of units; and
using the commingled and analyzed data to build a three-dimensional map of the environment.

11. The method of claim 10, comprising using the commingled and analyzed data to create a virtual environment.

12. The method of claim 10, wherein the communication regarding the collection of the data among the plurality of units comprises sharing three dimensional coordinate field of view boundary parameters of the environment captured by the three dimensional cameras and an approximate physical location, orientation, and directional heading of each of the persons, vehicles, or robots.

13. The method of claim 10, wherein the building of the three dimensional map comprises:
determining one or more views of the environment that are missing; and
providing instructions to the persons, vehicles, or robots such that data relating to the one or more missing views are captured.

14. The method of claim 13, wherein the determining the one or more missing views comprises an iterative and additive process and the capturing of the one or more missing views comprises model predictive control.

15. The method of claim 10, wherein the data from the two dimensional camera and sensor suite comprise two dimensional locations traversed by the person, vehicle, or robot, the data from the three dimensional camera comprise three dimensional point cloud data in world coordinates, and the data from the inertia measuring unit comprise six degrees of freedom (6DOF) tracking data.

16. The method of claim 15, wherein the commingling, analyzing, and building comprise:
performing re-localization of three dimensional landmarks in the environment;
using registered landmarks from two or more of the two dimensional camera, the three dimensional camera, and the multispectral camera in the extended Kalman filter to minimize mapping errors;
using a random sample consensus (RANSAC) process in the extended Kalman filter to identify inliers from visual feature correspondences between two or more of the two dimensional camera, the three dimensional camera, and the multispectral camera;
using camera tracking; and
using structure from motion (SfM) to estimate three dimensional coordinates for the landmarks.

17. The method of claim 10, comprising:
creating a three dimensional mesh from the three dimensional points;
mapping multi-spectral data for each region in the mesh; and
for every scene, using multi-spectral image boundary and field of view boundary parameters captured by the three dimensional cameras to perform a coarse registration.

18. The method of claim 10, wherein the sensor suite comprises one or more of a Bluetooth wireless low energy (BLE) device, an ultrasonic sensor, a proximity sensor, a radio frequency identification (RFID) device, an infrared radiation device, and an ultra-wide band (UWB) device.

19. A computer readable medium comprising instructions that when executed by a processor executes a process comprising:
communicating with a plurality of units, each of the plurality of units comprising one or more of a two dimensional camera, a three dimensional camera, a multispectral camera, a sensor suite, and an inertial measurement unit; wherein each of the plurality of units is associated with a person, a vehicle, or a robot and each of the units is operable to collect data relating to an environment;
receiving the data relating to the environment from the plurality of units;
using the data from each of the plurality of units to estimate the positions of the units and to track the positions of the units;
permitting the plurality of units to communicate with each other regarding the collection of the data relating to the environment;
commingling and analyzing the data from the plurality of units; and
using the commingled and analyzed data to build a three-dimensional map of the environment.

20. The computer readable medium of claim 19, wherein the commingling, analyzing, and building comprise:
performing re-localization of three dimensional landmarks in the environment;
using registered landmarks from two or more of the two dimensional camera, the three dimensional camera, and the multispectral camera in the extended Kalman filter to minimize mapping errors;
using a random sample consensus (RANSAC) process in the extended Kalman filter to identify inliers from visual feature correspondences between two or more of the two dimensional camera, the three dimensional camera, and the multispectral camera;
using camera tracking; and
using structure from motion (SfM) to estimate three dimensional coordinates for the landmarks.
